(19) United States
(12) Patent Application Publication
(10) Pub. No.: US 2011/0008745 A1
(43) Pub. Date: Jan. 13, 2011

(54) ORTHODONTIC BONE ANCHOR PLATE WITH MESH PAD

(76) Inventors: Paul McQuillan, Thorndale, PA (US); Richard Lessig, Phoenixville, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/864,906

(22) PCT Filed: Jan. 29, 2009
(86) PCT No.: PCT/US09/32346

§ 371 Date: Jul. 28, 2010

Related U.S. Application Data
(60) Provisional application No. 61/025,442, filed on Feb. 1, 2008.

(51) Int. Cl. A61C 7/14; A61C 8/00

(52) U.S. Cl. 433/18; 433/24

(57) ABSTRACT

An orthodontic anchorage system (10) is provided having a bone attachment portion (20), a bracket attachment plate (40), and a transmucosal neck (30) connected between the bone attachment portion and the bracket attachment plate. The bracket attachment plate has a mating surface (41) configured for adhesive attachment to a complementary mating surface (50) of an orthodontic bracket (51). The mating surface of the bracket attachment plate at least partially defines an internal void (44) that retains a portion of the adhesive (53) when the orthodontic bracket is attached to the bracket attachment plate.

### CROSS-REFERENCE TO RELATED APPLICATIONS

This application claims benefit of U.S. provisional application No. 61/025,442 filed Feb. 1, 2008, which is incorporated by reference herein in its entirety.

### TECHNOLOGY FIELD

This relates generally to orthodontic appliances and, more particularly, relates to an orthodontic bone anchor with an attachment plate for temporary or permanent attachment of orthodontic brackets.

### BACKGROUND

Orthodontic subperiosteal bone anchors are well known in the art. These implants permit an orthodontist or oral surgeon to position orthodontic appliances in a patient's mouth, without using the patient's teeth as anchors. An orthodontist may desire to use alternative orthodontic anchors to treat patients for conditions where molar anchorage may be too weak, such as for en mass retraction. Orthodontic bone anchors can be used for cases when patient outcomes are better, than if traditional molar anchorage is performed.

Typically, orthodontic bone anchors incorporate an integral orthodontic bracket or other orthodontic appliance. However, these anchors present the problem of requiring additional surgery to change the type of integrated bracket or bone anchor to complete the patient's treatment. Some orthodontic bone anchors incorporate orthodontic appliances that require screws and other attachment hardware to be adapted for orthodontic use. However, these anchors can not be used with standard orthodontic brackets that are widely available to any orthodontist.

### SUMMARY

This Summary is provided to introduce a selection of concepts in a simplified form that are further described below in the Detailed Description of Illustrative Embodiments. This Summary is not intended to identify key or essential features, nor is it intended to be used to limit the scope of the invention as defined by the claims.

The disclosed bone anchor has many of the benefits of a typical implanted orthodontic bone anchor, but it also allows an orthodontist to use ordinary bonding material to attach orthodontic brackets and other orthodontic appliances to the incorporated bracket attachment plate. The bonding attachment may be either permanent or temporary, which allows quick removal of the attached orthodontic bracket, thereby obviating the need for additional patient surgeries to replace or reposition the orthodontic bracket or other appliance if it is damaged or no longer needed in a particular form.

In a preferred embodiment, the disclosed bone anchor also includes a surface that is somewhat curved or faceted, like the outer surface of a tooth. This allows an orthodontist to use the bone anchor during orthodontic treatment as he or she would use a patient's tooth. Ordinary bonding material can be used to attach commonly available orthodontic brackets to the anchor, just as if the incorporated bracket attachment plate was a tooth. Also, because the bond strength between the bracket attachment plate and an orthodontic bracket is similar to that between a patient's tooth and an orthodontic bracket, removal of a bracket from the bone anchor is just as easy and convenient as removal of a bracket from a patient's tooth.

Additional features and advantages will be made apparent from the following detailed description of illustrative embodiments that proceeds with reference to the accompanying drawings.

### BRIEF DESCRIPTION OF THE DRAWINGS

The foregoing summary, as well as the following detailed description, is better understood when read in conjunction with the appended drawings. For the purpose of illustrating the reconstruction device and related method thereof, there is shown in the drawings exemplary embodiments; however, the reconstruction device and related methods are not limited to the specific embodiments and methods disclosed. Like reference numerals refer to corresponding parts throughout the several embodiments of the drawings.

FIG. 1 is a perspective view of an orthodontic bone anchor constructed in accordance with one example embodiment;

FIG. 2 is a top view of the orthodontic bone anchor illustrated in FIG. 1;

FIG. 3 is a side view of the orthodontic bone anchor illustrated in FIG. 1;

FIG. 4A is a top view of a bracket attachment plate portion of the orthodontic bone anchor illustrated in FIG. 1;

FIG. 4B is a front cross sectional view of the bracket attachment plate illustrated in FIG. 4A;

FIG. 4C is a schematic front view of a bracket attachment plate constructed in accordance with an alternative embodiment;

FIG. 4D is a front cross-sectional view of a bracket attachment plate similar to that illustrated in FIG. 4B, but defining internal voids constructed in accordance with an alternative embodiment.

FIG. 5A is a schematic top view of a bracket attachment plate constructed in accordance with an alternative embodiment;

FIG. 5B is a schematic top view of a bracket attachment plate constructed in accordance with another alternative embodiment;

FIG. 5C is a schematic top view of a bracket attachment plate constructed in accordance with still another alternative embodiment;

FIG. 5D is a schematic front cross-sectional view of the bracket attachment plate illustrated in FIG. 5C; and

FIG. 5E is a schematic top view of a bracket attachment plate constructed in accordance with yet another alternative embodiment;

FIG. 5F is a schematic perspective view of the bracket attachment plate illustrated in FIG. 5E;

### DETAILED DESCRIPTION OF ILLUSTRATIVE EMBODIMENTS

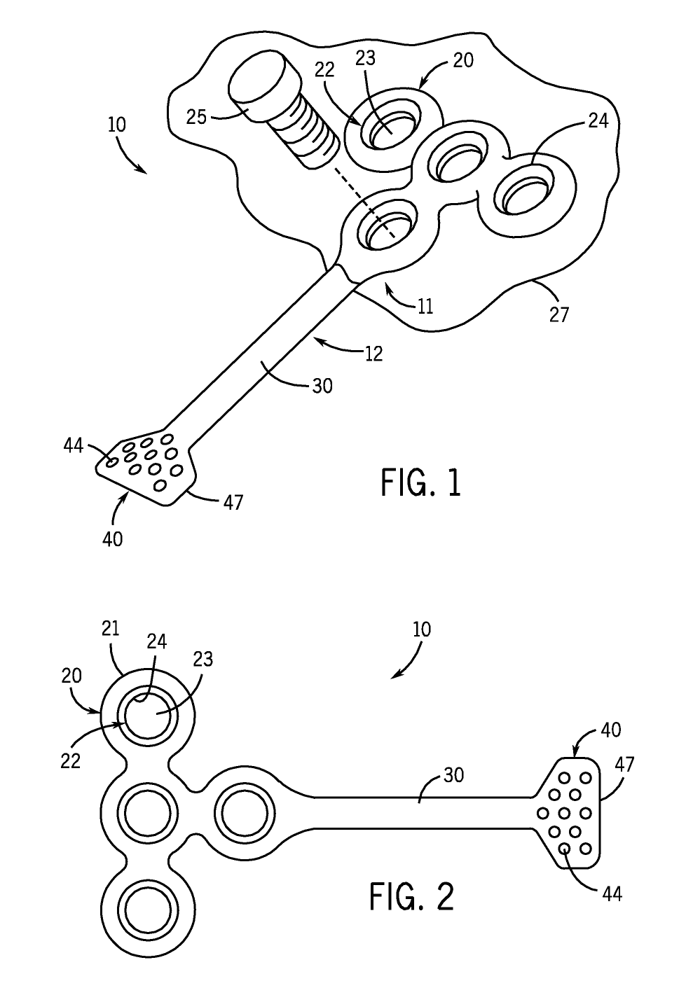

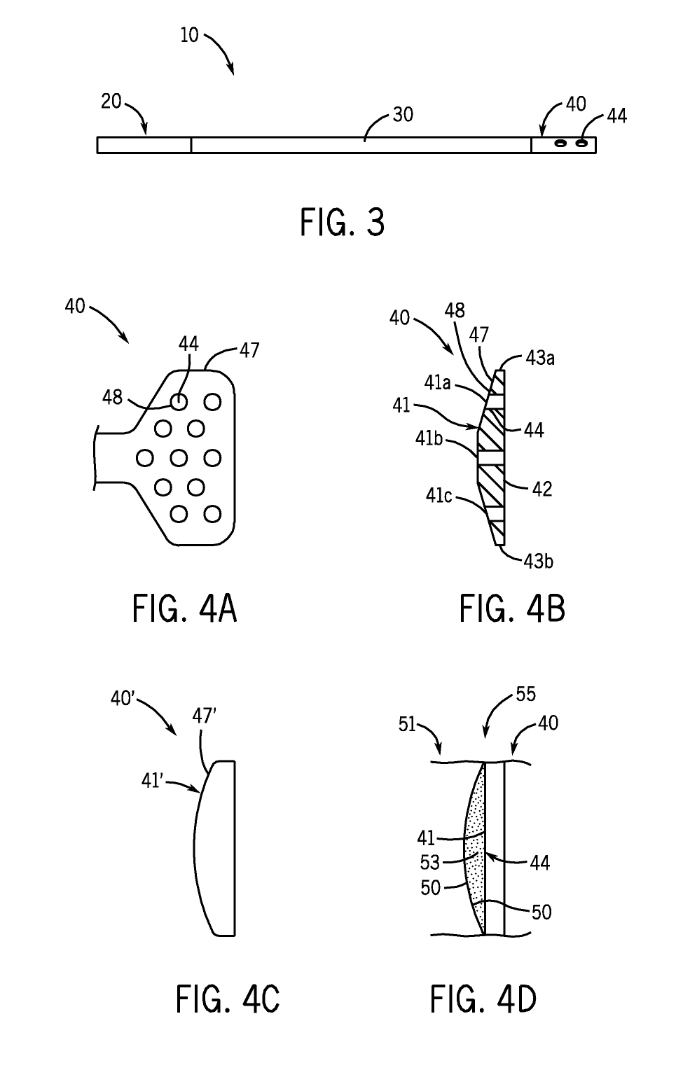

Referring to FIGS. 1-3, an orthodontic bone anchor 10 includes a bone attachment portion 20, a transmucosal neck 30, and a bracket attachment plate 40. Unless otherwise specified, the orthodontic bone anchor 10 and its components can be made from a biocompatible and malleable metallic material, such as titanium, a titanium alloy, or any other suitable biocompatible material. The orthodontic bone anchor 10 can be made from a single integral piece of material, such as titanium, or can alternatively be made from multiple components (e.g., the bone attachment portion 20, the transmucosal neck 30, and the bracket attachment plate 40) that are attached together, via welding, gluing, or any other suitable temporary or permanent attachment mechanism.

For example, in one embodiment, the orthodontic bone anchor 10 can be provided as a two-piece construction having a first piece 11 and a second piece 12. The first piece 11 includes the bone attachment portion 20, and the removable second piece 12 includes the transmucosal neck 30 and the bracket attachment plate 40. When the orthodontic bone anchor 10 is installed in a patient by an oral surgeon, the two component pieces are joined together by a temporary attachment mechanism, such as miniscrews or bolts, or an adhesive or like fastener. It should thus be appreciated that the first piece 11 can include a portion of a neck or other structure suitable for connection to the elongate neck 30.

When the pieces 11 and 12 are connected, the transmucosal neck 30 and the bracket attachment plate 40 are exposed to a patient's oral cavity. After orthodontic treatment is complete, the orthodontist can detach the second piece (including the neck 30 and the attachment plate 40) from the first piece and remove it from the patient's mouth, leaving the first piece (including the bone attachment portion 20) in the patient's mouth. The piece that is left behind in the patient's mouth is not exposed to the patient's oral cavity, thereby eliminating the necessity for additional oral surgery to remove the entire bone anchor 10 assembly.

Alternatively, the bone anchor 10 can be provided as a three piece construction having a first piece that includes the bone attachment portion 20, a second piece that includes the transmucosal neck 30, and a third piece that includes the bracket attachment plate. The three pieces can be removably connected to each other in the manner described above with respect to the two-piece construction.

In this regard, it should be appreciated that a modular kit can be provided that includes all or a portion of the bone anchor 10 as described herein. For example, the kit can include components such as one or both detachable pieces of the bone anchor as described above. Furthermore, the kit can include components such as one or more orthodontic brackets 51 as shown in FIG. 4D. The one or more components included in various kits can have one or more varying characteristic such as size and/or shape. As one example, the neck 30 can vary in length, cross-sectional shape, material, and the like, as described in more detail below. As another example, the bone attachment portion 20 can have varying numbers of holes 22, or holes 22 of different diameters, as described in more detail below. As yet another example, the bracket attachment plate 40 can be of different sizes and shapes, as described in more detail below.

A first kit can thus be provided having one or more components of one size or shape, and one or more other kits can include the same one or more components as the first kit, but of a size and/or shape that is different from those in the first kit. Alternatively, the one or more other kits can include different components from the first kit. Alternatively or additionally, a kit can include a plurality of the same component, but of different sizes and/or shapes. For instance, a kit can include a plurality of first pieces of the bone anchor 10, second pieces of the bone anchor 10, fasteners, and/or orthodontic brackets 51 of varying sizes and/or shapes. The components can be stored and later assembled into a bone anchor 10, or bone anchorage system that includes the bone anchor and the orthodontic bracket 51, thereby imparting flexibility onto the surgical procedure.

The bone anchor 10 may be easily bendable by standard orthodontic or oral surgery instruments, or it may be more stiff and resistant to bending. It may be desired to bend portions of the orthodontic bone anchor 10 (e.g., the bone attachment portion 20 or the transmucosal neck 30) to match the shape of a patient's mandible or maxilla 27 at the point where the orthodontic bone anchor 10 will be attached, so that the strength of the coupling of the bone anchor 10 to the patient's bone is increased.

Referring now also to FIG. 2, the bone attachment portion 20 includes a bone attachment body 21 that defines a plurality of bone attachment locations 22. In the illustrated embodiment, the bone attachment locations 22 are provided as holes 23 that extend through the bone attachment body 21. In particular, the bone attachment body 21 includes a plurality of interior surfaces 24 that, in turn, define a corresponding plurality of bone attachment holes 23.

The bone attachment portion 20 is illustrated as including four bone attachment holes 23. However, it should be appreciated that the bone attachment portion 20 may include any number of bone attachment holes 23, such as five or more, or less than four, to achieve a suitable attachment between the bone anchor 10 and a patient's mandible or maxilla 27. In this regard, the bone attachment portion 20 can include at least one bone attachment hole 23. In one embodiment, a fastener 25, such as a miniscrew, bolt, nail, or other suitable fastener, can be inserted through the bone attachment body 21 at one or more, up to all, of the attachment locations 22, and fastened to the patient's mandible or maxilla 27. In the illustrated embodiment, the fasteners are inserted through the bone attachment holes 23, which can be threaded or unthreaded, depending on the fasteners that are used. For instance, the bone attachment holes 23 can be threaded, such that threaded miniscrews, bolts, or the like can mate with the threads of the bone attachment holes 23.

With continuing reference to FIGS. 1-3, the transmucosal neck 30 extends horizontally along a longitudinal direction of elongation between the bone attachment portion 20 and the bracket attachment plate 40. It should be appreciated that while the directional terms such as “horizontal” and “vertical” are used herein with respect to the bone anchor 10 as illustrated in a horizontal orientation, these directions may vary depending on the actual orientation of the bone anchor during use.

The neck 30 can have any desired length and any desired cross-sectional shape, depending for instance on the desired orthodontic system application that the orthodontic bone anchor will have in any particular patient. In one embodiment, the transmucosal neck 30 has a cross-sectional shape that is rectangular with rounded corners. The neck 30 may also have a cross-sectional shape that is circular, elliptical, tear-drop shaped, square with rounded corners, hexagonal with rounded corners, or any other shape that gives the neck 30 the desired bending strength and does not cut or irritate the surrounding gum tissues in a patient's mouth.

In some applications, it may be desirable to bend portions of the transmucosal neck 30 (or the bracket attachment plate 40) so that a mating surface 41 of the bracket attachment plate 40 has an orientation that is best suitable for the orthodontic system. For example, the transmucosal neck 30 may be bent inward towards a patient's tongue or laterally towards a patient's molars such that the bracket attachment plate 40 is positioned at a particular angle to more easily allow for accurate positioning of an orthodontic bracket that is bonded to the bracket attachment plate 40 within the orthodontic system.

Alternatively still, while the transmucosal neck 30 is illustrated as extending horizontally, it should be appreciated that the transmucosal neck 30 can alternatively extend in a direction angled with respect to the horizontal. Furthermore, the transmucosal neck can extend straight as illustrated, or can be curved, or can include a plurality of straight segments that are angled with respect to each other. Alternatively still, while one transmucosal neck 30 is illustrated as connected between the bone attachment portion 20 and the bracket attachment plate 40, it should be appreciated that any number of transmucosal necks, including at least one, can connect between the bone attachment portion 20 and the bracket attachment plate 40.

Referring now to FIGS. 4A-4B, the bracket attachment plate 40 includes a bracket attachment plate body 47 that can define a mating surface 41, to which orthodontic brackets are temporarily or permanently bonded, in order to accomplish an orthodontic or oral surgery purpose (e.g., to move one or multiple teeth), a non-mating surface 42, and lateral surfaces 43a and 43b that extend between and are connected to the surfaces 41 and 42. It should be appreciated, however, that the bracket attachment plate 40 can have any desired geometrical configuration.

While one mating surface 41 is illustrated, it should be appreciated that the attachment plate 40 could alternatively include multiple mating surfaces depending on the desired number of brackets that are to be attached to the attachment plate 40. For instance, the attachment plate could define two mating surfaces 41 disposed at any suitable location on the attachment plate 40, for instance on opposing sides of the bracket attachment plate 40. Alternatively, three or more mating surfaces 41 could be located at any suitable location on the attachment 40. In this regard, the attachment plate 40 includes at least one mating surface 41 to which a complementary mating surface of an orthodontic bracket can be temporarily or permanently bonded with adhesive material (not shown) or other like fastener.

The bracket attachment plate body 47 can define one or more enhanced attachment locations 48, such as internal voids 44 that extend vertically into or through the bracket attachment plate body 47. The internal voids 44 may alternatively, of course, extend at any desired angle with respect to the vertical. The mating surface 41 can include flat surface segments, such as a pair of side surface segments 41a and 41c, and a central surface segment 41b. The central flat surface segment 41b is substantially parallel to the non-mating surface 42, and side flat surface segments 41a and 41c are angled with respect to the center flat surface segment 41b, such that the three flat surface segments form an outwardly convex surface. Thus, the central flat surface segment 41b can define an angle with each of the side flat surface segments 41a and 41c that may be any anywhere between 0° and 90°, depending for instance on the shape of the mating surface of the orthodontic bracket.

It should be appreciated that the flat surface segments 41a, 41b, and 41c may form any shape, and the overall shape of surface 41 may be outwardly convex, flat, or outwardly concave. In other embodiments, the mating surface 41 can include two, or more than three flat surface segments. For example, the mating surface 41 may consist of a single flat segment, it may consist of two flat surface segments, or it may consist of many flat surface segments 41 that, when taken together, approximate an outwardly convex curved shape.

Alternatively, as can be seen in FIG. 4C, the mating surface 41′ may be a single, smooth, curved shape. A curved mating surface 41′ may take any shape, including a segment of a sphere, an elliptical shape, or it may have multiple curved segments, similar to a complex or simple pattern of ripples. In this regard, the bracket attachment plate 40 can be said to include a mating surface having at least one mating surface segment, which can be curved or flat.

The illustrated embodiment recognizes that orthodontic brackets can be generally curved to substantially match the surfaces of teeth in an oral cavity, and can further be designed for use on specific teeth. The outwardly convex mating surface 41 of the bracket attachment plate 40 can have a generalized surface shape that approximates the complementary mating surface of orthodontic brackets including those that are designed for use on specific teeth.

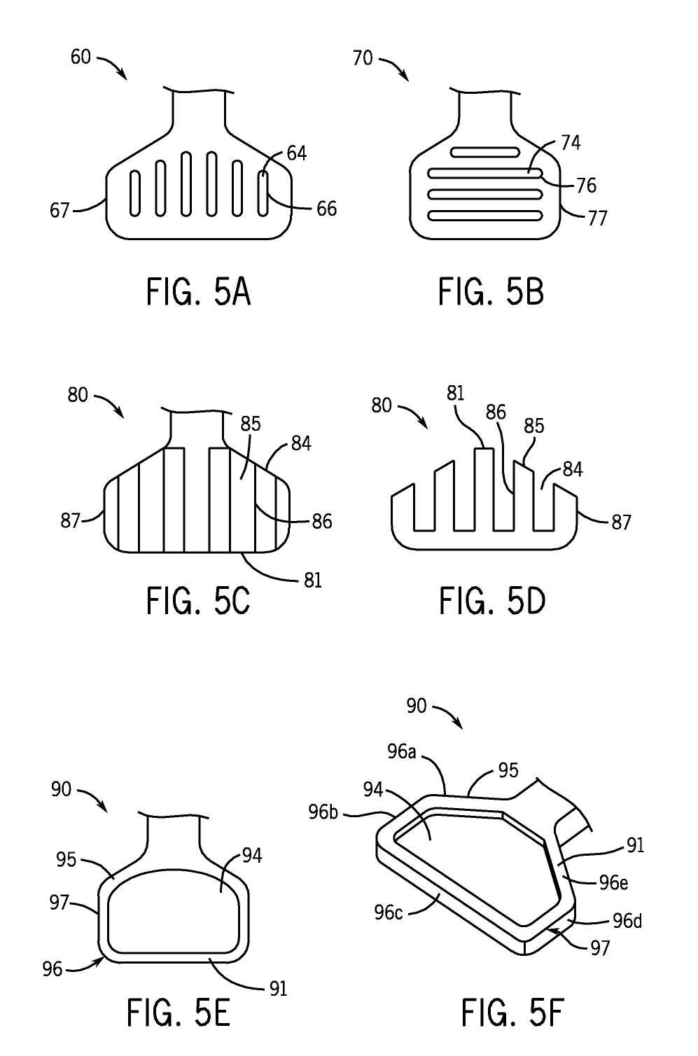

With continuing reference to FIGS. 1-4B, the internal voids 44 are arranged to define a mesh-like pattern through bracket attachment plate 40. Thus, the bracket attachment plate body 47 can define a mesh pad design of internal voids 44 extending therein or therethrough. The internal voids 44 can provide areas for portions of bonding material to remain deposited (i.e., not squeeze out completely) on the attachment plate 40 when the mating surface of an orthodontic bracket is pressed against the mating surface 41 of the attachment plate 40. Therefore, the internal voids 44 may take any shape, be any size, penetrate to any depth from the mating surface 41 within the attachment plate 40 (partial or complete penetration, or a combination of various levels of penetration), or be of any number of internal voids, including even a single void 44 (an example of a single void 44 is shown in FIGS. 5E and 5F).

For example, while the internal voids are illustrated in FIG. 4A as circular, they can assume any other geometric shape or combination of shapes, such as holes, slots, or blind trenches, such as ovals, triangles, rectangles, hexagons, octagons, or other regular or irregular polygons. A mesh pattern of voids (mesh pad design) may contain eleven internal voids 44, as seen in FIG. 4A, or the mesh pattern may contain any other number of internal voids 44 greater than or less than eleven (but at least one). The internal voids 44 may all have the same shape and diameter, as seen in FIG. 4A, or they may assume different shapes (and diameters) with respect to each other. In a preferred embodiment, the internal voids 44 penetrate completely through the attachment plate 40. In other embodiments, the internal voids 44 penetrate only partially through the attachment plate 40. In some embodiments, the internal voids 44 may be very shallow, for example, where the mating surface 41 is knurled or rough. In this situation, there are still small internal voids contained within the knurled or rough mating surface 41 to provide a benefit of some bonding material remaining deposited on the attachment plate 40 after an orthodontic bracket is attached.

In still other embodiments, the mating surface 41 may be a smooth flat surface, such that the internal voids 44 do not extend into the mating surface 41, but are rather defined between the mating surface 41 and a complementary mating surface 50 of an orthodontic bracket 51 as illustrated in FIG. 4D. In these embodiments, while the internal voids 44 may or may not extend into the mating surface 41, some bonding material 53 may still remain deposited on the attachment plate 40 (providing an attachment strength benefit), when for instance the mating surface 41 has a radius of curvature that is different from that of the mating surface 50 of the orthodontic bracket 51. For instance, the radius of curvature of the mating surface 41 of the attachment plate 40 is infinite when flat and smooth, while the radius of curvature of the mating surface 50 of the orthodontic bracket 51 is finite such that an internal void 44 is defined between the mating surfaces 41 and 50. Thus, an orthodontic anchorage system 55 can be provided that includes the bone anchor 10 and the orthodontic bracket 51.

Accordingly, whether one or more internal voids 44 extend into the mating surface 41, or whether one or more internal voids 44 are defined between the mating surfaces 41 and 50, it can be said that the attachment plate 40, or attachment plate body 47, at least partially defines one or more internal voids 44. The internal voids 44 can be formed at the mating surface, which includes internal voids that extend through the mating surface 41. For instance, when the internal voids 44 extend into or through the mating surface 41, it can be said that the mating surface 41 defines the internal voids 44. When the internal voids 44 are fully defined when the complementary mating surface 50 engages or is attached to the mating surface 41, it can be said that the mating surface partially defines the internal voids 44.

As described above, and with reference to FIGS. 5A-5F, the internal voids can assume shapes other than those illustrated in FIGS. 1-4B. FIG. 5A, for instance, illustrates a bracket attachment plate 60 having reference numerals corresponding to like structure of the bracket attachment plate 40 incremented by 20. FIGS. 5B-5F illustrate bracket attachment plates having reference numerals corresponding to like structure of the bracket attachment plate 40 incremented in denominations of 10 with respect to the reference numerals corresponding to elements of the previously described embodiment.

As shown in FIG. 5A, the attachment plate 60 has an attachment plate body 47 that at least partially defines internal voids 64 as substantially longitudinally elongate slots 66 that extend substantially parallel to the direction of elongation of the transmucosal neck 30. While six slots 66 are illustrated, it should be appreciated that the attachment plate 60 can include at least one slot 66, including less than six slots 66 and greater than six slots 66. It should be further appreciated that the slots 66 can penetrate partially or completely through attachment plate body 67, or can alternatively be defined as described above with respect to the internal voids 44.

As shown in FIG. 5B, the attachment plate 70 has an attachment plate body 77 that at least partially defines internal voids 74 as substantially laterally elongate slots 76 that extend substantially perpendicular to the direction of elongation of the transmucosal neck 30. While four slots 76 are illustrated, it should be appreciated that the attachment plate 70 can include at least one slot 76, including less than four slots 76 and greater than four slots 76. It should be further appreciated that the slots 76 can penetrate partially or completely through attachment plate body 77, or can alternatively be defined as described above with respect to the internal voids 44.

In addition to slots that extend substantially parallel or perpendicular to transmucosal neck 30, other embodiments have slots that define other angles with respect to the transmucosal neck 30, such as between 0° and 90°. The slots of a given attachment plate may define the same angle with respect to the transmucosal neck 30, or can define different angles with respect to the transmucosal neck.

Referring now to FIGS. 5C-D, the attachment plate 80 has an attachment plate body 87 that includes a plurality of substantially vertical notches 86. Of course, it should be appreciated that the notches 86 can alternatively extend at any desired angle with respect to the vertical. The notches further extend substantially longitudinally, thereby defining a plurality of internal voids 84 disposed between laterally adjacent notches 86. It should be appreciated that the cross-sectional shape of the internal voids 84 and notches 86 may be substantially rectangular or may be configured as any other desired any other shape, including a triangular shaped cross-section, a trapezoidal shaped cross-section, and a parabolic shaped cross-section.

The notched attachment plate body 87 can also define fins 85 disposed at the upper end of the notches 86. In this embodiment, as can be seen in FIG. 5D, the outer, upward-facing surfaces of fins 85 combine to define the mating surface 81 of the attachment plate body 87. While the fins 85 combine to define the mating surface 81 as convex with respect to the mating surface of an orthodontic bracket, it should be appreciated that the mating surface 81, along with any of the alternative mating surfaces illustrated in FIGS. 5A, 5B, 5E, and 5F, can define any shape as desired to engage and mate with the mating surface of the orthodontic bracket, including one or more flat surface portions, set at any desired angle with respect to each other, or one or more curved mating surface portions which can be concave or convex with respect to the mating surface of the orthodontic bracket.

In addition, or as an alternative, to the configuration of internal voids 84, and notches 86 and the corresponding fins 45 as shown in FIGS. 5C-D, any number of internal voids, notches, and fins, including at least one, may be provided. Furthermore, the notches and fins may extend at any angle relative to the neck 30.

Referring now to FIGS. 5E and 5F, the attachment plate 90 has an attachment plate body 97 having a substantially vertical peripheral notch 96. Of course, it should be appreciated that the notch 96 can alternatively extend at any desired angle with respect to the vertical. The notch 96 can include a plurality of interconnected notch segments 96a-96e that cumulatively, in combination with the neck 30, circumscribes a single internal void 94. In the illustrated embodiment, the notch defines an outer perimeter of the attachment plate body 97, though the notch can be positioned at any desirable location on the attachment plate body 97, including a location that is inwardly recessed with respect to the outer perimeter of the attachment plate body 97. The internal void 94 is illustrated as a pan-shaped hole or void that penetrates partially through attachment plate 40, though the void 94 could be configured having any desired size and/or shape, such as a smoothly-varying curve, a regular polygon, or an irregular polygon, with any number of sides. In this regard, while five notch segments 95a-96e are illustrated, it should be appreciated that the notch 96 can be formed from one or more curved or straight notch segments. Furthermore, the pan-shaped void 44 may penetrate partially or completely through attachment plate body 47.

The attachment plate body 97 defines a fin 95 disposed at the upper end of the notch 96, or each notch segment 96a-e. While the fin 95 corresponding to each notch segment is disposed at a height substantially equal to that of the neck 30, each fin 95 can alternatively be disposed below or above the neck 30. It should be appreciated that the surface upward-facing surfaces of the fins 45 may combine to form the mating surface 91 having any desirable shape as described above.

The orthodontic bracket (such as that illustrated in FIG. 4D) may be any orthodontic bracket that an orthodontist or oral surgeon may require for a patient's treatment (e.g., moving one or multiple teeth). Any orthodontic appliance that can be mated to an orthodontic bracket may be applied. The orthodontist could apply archwires, ligature wires, elastics, springs, power chains, and various other orthodontic appliances directly to the orthodontic bracket that is bonded to a bracket attachment plate of the type described herein as if it were an orthodontic bracket that was bonded to a tooth. The bracket attachment plate can then be used to position orthodontic bracket, which would accommodate orthodontic appliances for any orthodontic procedure. The orthodontic bone anchor 10 and its incorporated bracket attachment plate may also be used for orthognathic surgery applications (e.g., to correct conditions of the jaw and face related to structure, growth, sleep apnea, and TMJ disorders, or to correct orthodontic problems that cannot be easily treated with braces).

The orthodontic bracket defines an orthodontic bracket mating surface that may be temporarily or permanently bonded to the mating surface of a bracket attachment plate of the type described herein with bonding or adhesive material (such as material 53 shown in FIG. 4D). In a preferred embodiment, adhesive material is a UV adhesive, which bonds the orthodontic bracket to the bracket attachment plate. However, other types of temporary and permanent orthodontic bonding agents known in the art may be used. In one embodiment, when a Unitek brand UV cured adhesive material commercially available from 3M Corporation, headquartered in St. Paul, Minn., is used to bond an orthodontic bracket to tooth enamel, the mean shear strengths can vary from approximately 19 to 28 MPa (megaPascal) In another embodiment, the attachment bond of the Unitek brand UV cured adhesive material disposed between the orthodontic bracket and a metallic surface can have a bond shear strength from approximately 10 to 30 MPa. As a result, when an orthodontic bracket is attached to the bracket attachment plate 40 using Unitek brand UV cured adhesive material, the bond strength reduces the likelihood of the orthodontic bracket becoming inadvertently detached from the attachment plate, but permits the user to detach the orthodontic bracket from the attachment plate 40 when desired.

The foregoing description is provided for the purpose of explanation and is not to be construed as limiting the invention. While various embodiments have been described with reference to preferred embodiments or preferred methods, it is understood that the words which have been used herein are words of description and illustration, rather than words of limitation. Furthermore, although the embodiments have been described herein with reference to particular structure, methods, and embodiments, the invention is not intended to be limited to the particulars disclosed herein. Those skilled in the relevant art, having the benefit of the teachings of this specification, may effect numerous modifications to the invention as described herein, and changes may be made without departing from the spirit and scope of the invention as defined by the appended claims.

What is claimed:

1. An orthodontic anchor for attaching an orthodontic appliance to a mandible, the orthodontic anchor comprising:
a bone attachment portion comprising a bone attachment body having a plurality of bone attachment locations for bone screws to anchor the bone attachment portion to the mandible;
a bracket attachment plate comprising a mating surface designed to mate with an orthodontic appliance, wherein the bracket attachment plate at least partially defines at least one internal void at the mating surface; and
a transmucosal neck connected between the bone attachment portion and the bracket attachment plate.

2. The orthodontic anchor as recited in claim 1, further comprising two pieces configured for removable connection to each other, wherein the first piece comprises the bone attachment portion and the second piece comprises the bracket attachment plate.

3. The orthodontic anchor as recited in claim 2, wherein the second piece further comprises the transmucosal neck.

4. The orthodontic anchor as recited in claim 1, wherein the mating surface defines an outwardly convex surface.

5. The orthodontic anchor as recited in claim 1, wherein the bracket attachment plate further comprises a bracket attachment plate body that has the mating surface and defines the at least one internal void, and the at least one internal void is a hole extending into the mating surface.

6. The orthodontic anchor as recited in claim 5, wherein the hole penetrates entirely through the bracket attachment plate body.

7. The orthodontic anchor as recited in claim 5, wherein the penetrates partially but not entirely through the bracket attachment plate body.

8. The orthodontic anchor as recited in claim 1, wherein the internal void is an elongate slot.

9. The orthodontic anchor as recited in claim 8, wherein the slot extends into but does not penetrate completely through the bracket attachment plate body.

10. The orthodontic anchor as recited in claim 5, wherein the hole is defined by an outer perimeter of the bracket attachment plate body.

11. The orthodontic anchor as recited in claim 1, wherein the internal void is defined by the mating surface in combination with a complementary mating surface of an orthodontic bracket.

12. A bracket attachment plate for use in an orthodontic anchor, the bracket attachment plate comprising:
a bracket attachment plate body defining a mating surface configured to engage a complementary mating surface of an orthodontic bracket, wherein the bracket attachment plate body at least partially defines at least one internal void at the mating surface.

13. The bracket attachment plate as recited in claim 12, wherein the internal void comprises a hole extending through the bracket attachment plate body.

14. The bracket attachment plate as recited in claim 12, wherein the internal void comprises a hole extending into, but not through, the bracket attachment plate body.

15. The bracket attachment plate as recited in claim 12, wherein the mating surface of the bracket attachment plate body is outwardly convex.

16. The bracket attachment plate as recited in claim 15, wherein the mating surface of the bracket attachment plate body comprises a plurality of mating surfaces that are angled with respect to each other.

17. The bracket attachment plate as recited in claim 12, wherein the internal void is defined by the mating surface of the bracket attachment plate body in combination with the complementary mating surface of the orthodontic bracket.

18. A modular orthodontic bone anchor kit comprising:
a plurality of bracket attachment plates for use in an orthodontic anchor, each bracket attachment plate comprising:
a bracket attachment plate body defining a mating surface configured to engage a complementary mating surface of an orthodontic bracket, wherein the bracket attachment plate body at least partially defines at least one internal void at the mating surface, wherein each of the plurality of bracket attachment plates has at least one varying characteristic.

19. A method for attaching an orthodontic appliance to a mandible, the steps comprising:
providing a bone attachment portion and a bracket attachment plate;
anchoring the bone attachment portion to the mandible, such that the bone attachment portion is coupled to the bracket attachment plate;
attaching the orthodontic appliance to a mating surface of the bracket attachment plate, such that at least one internal void is at least partially defined by the bracket attachment plate at the mating surface.
